(19) United States
(12) Patent Application Publication
(10) Pub. No.: US 2015/0313692 A1
(43) Pub. Date: Nov. 5, 2015

(54) METHODS AND TOOLING FOR DENTAL IMPLANT

(71) Applicant: Amiram VIZANSKI, Herzlia (IL)

(72) Inventor: Amiram VIZANSKI, Herzlia (IL)

(21) Appl. No.: 14/439,704

(22) PCT Filed: Oct. 30, 2013
(86) PCT No.: PCT/IL2013/050885

§ 371 Date: Apr. 30, 2015

Related U.S. Application Data
(60) Provisional application No. 61/719,978, filed on Oct. 30, 2012.

(51) Int. Cl. A61C 8/00

(52) U.S. Cl. CPC A61C 8/0089; A61C 8/0001; A61C 8/005

(57) ABSTRACT

A method of implanting a fixture for a dental implant and taking an impression including, during a procedure drilling a hole in mucosa while simultaneously drilling a smaller diameter concentric pilot hole in a jaw bone with the same drill, inserting an implant fixture including an abutment connection socket into the jaw bone, wherein a stub is connected to the abutment connection socket, placing a material for dental impression into a volume which includes the stub, and pulling the dental impression off the implant fixture. Related apparatus and methods are also described.

### RELATED APPLICATION/S

This application claims priority from U.S. Provisional Patent Application No. 61/719,978 filed 30 Oct. 2012. The contents of the above application are incorporated by reference as if fully set forth herein.

### FIELD AND BACKGROUND OF THE INVENTION

The present invention, in some embodiments thereof, relates to methods and tooling for dental implant insertion and impression, and more particularly, for methods and tooling for simplified dental implant and to methods and tooling for dental impression.

In the 1960s dental implantation was developed by Prof. Branemark. At that time, a protocol which has become an industry consensus for dental implant insertion into bone, included a dissection of the gingivae over the bone in a targeted implant insertion point, drilling exposed bone structure with a cooled drill (because bone is a living tissue and is susceptible to heat emitted from drilling), implant insertion and thread creation in the bone structure, then, when the process of the implant insertion into the bone is complete, the bone is covered at the implant area with the gingival flap and the operator sutures the gingivae to its original location.

The above procedure, since it is a surgical procedure by nature, according to the Branemark protocol, should be performed by dental professionals who are qualified for dental surgery, for example dental surgeons or periodontists who receive an extended education in the field of surgical dentistry. The protocol also restricts the procedure for dental implant insertion to be performed in a sterile environment.

The disclosures of all references mentioned above and throughout the present specification, as well as the disclosures of all references mentioned in those references, are hereby incorporated herein by reference.

### SUMMARY OF THE INVENTION

According to some embodiments of the present invention, a dental implant and taking an impression of a crown or a prosthetic tooth for the dental implant are performed in one procedure. A method for so doing is described herein. Dental implant components and tooling which potentially aid in the procedure and/or potentially improve the quality and increase the lifetime of a dental implant are also described herein.

According to an aspect of some embodiments of the present invention there is provided a method of implanting a fixture for a dental implant and taking an impression including, during a procedure drilling a hole in mucosa while simultaneously drilling a smaller diameter concentric pilot hole in a jaw bone with the same drill, inserting an implant fixture including an abutment connection socket into the jaw bone, wherein a stub is connected to the abutment connection socket, placing a material for dental impression into a volume which includes the stub, and pulling the dental impression off the implant fixture.

According to some embodiments of the invention, the pulling the dental impression off the implant fixture includes pulling the dental impression and the stub both off the implant fixture.

According to some embodiments of the invention, the stub includes an implant carrier.

According to some embodiments of the invention, the inserting the implant fixture into the jaw bone includes inserting the implant fixture into the jaw bone using the implant carrier attached to the abutment connection socket of the implant fixture.

According to some embodiments of the invention, further including, after drilling the smaller diameter concentric pilot hole in the jaw bone, drilling out the pilot hole in the jaw bone to a diameter suitable for inserting an implant fixture.

According to some embodiments of the invention, further including, during the procedure, attaching a provisional prosthetic tooth to the implant fixture.

According to some embodiments of the invention, further including, during the procedure, attaching a provisional prosthetic crown to the implant fixture.

According to an aspect of some embodiments of the present invention there is provided an implant carrier for attaching to a dental implant fixture including a head having at least a portion configured for accepting a rotation-imparting tool, for transferring rotation from a mating rotation-imparting tool, a shank section including a recess for impression material, and a radially expandable insert sized for inserting into a socket in a dental implant fixture.

According to some embodiments of the invention, the radially expandable insert includes one or more slits axially along the insert for enabling the insert to compress radially when the insert is pushed radially inward.

According to some embodiments of the invention, the radially expandable insert includes at least a portion configured for imparting rotation to a mating portion for accepting imparted rotation in the dental implant fixture.

According to some embodiments of the invention, the portion configured for accepting a rotation-imparting tool includes a polygonal radial cross section, corresponding to a polygonal radial cross section of the mating rotation-imparting tool. According to some embodiments of the invention, the polygonal radial cross section is hexagon shaped.

According to some embodiments of the invention, the head and the shank are similar in shape to a head and a shank of a dental implant abutment.

According to some embodiments of the invention, the radially expandable insert shape is similar in shape to an abutment connection socket in a dental implant fixture.

According to some embodiments of the invention, an outer surface of at least part of the radially expandable insert shape is configured to produce a self-locking taper in conjunction with an inner surface of a corresponding a dental implant fixture.

According to some embodiments of the invention, the shank includes a shoulder perpendicular to a longitudinal axis of the implant carrier. According to some embodiments of the invention, the shank includes a groove.

According to some embodiments of the invention, the portion of the insert configured for imparting rotation includes a polygonal radial cross section. According to some embodiments of the invention, the polygonal radial cross section includes a hexagon shape.

According to an aspect of some embodiments of the present invention there is provided a dental implant fixture for implanting into a jaw bone, the dental implant fixture including an elongate shape, wherein a tip of the elongate shape includes an abutment connection socket configured for attaching an abutment, the abutment connection socket includes at least one portion having a cross section area larger than a cross section area of a second portion more proximal to the tip.

According to some embodiments of the invention, a ledge is formed between the larger cross section and the smaller cross section.

According to some embodiments of the invention, an angle of the ledge is less than 90 degrees to a longitudinal axis of the elongate shape.

According to some embodiments of the invention, the socket includes, at least somewhere along a length of the socket, a polygonal cross section, configured to accept a tool tip including the polygonal cross section, the tool tip configured to transfer rotational torque to the elongate shape.

According to some embodiments of the invention, the tool tip is included in an implant carrier.

According to some embodiments of the invention, the polygonal cross section is a hexagon shape.

According to some embodiments of the invention, a shoulder is formed at the proximal tip between a circumference of the elongate shape and the socket, and an angle of the ledge is more than 90 degrees to a longitudinal axis of the elongate shape.

According to some embodiments of the invention, an inner surface of the abutment connection socket is configured to produce a self-locking taper in conjunction with an outer surface of a corresponding insert.

According to an aspect of some embodiments of the present invention there is provided a dental implant abutment for attaching to a dental implant fixture including a head configured for attachment of a dental prosthesis, a shank section, ending at a shoulder configured to contact a corresponding shoulder of a dental implant fixture, and a radially expandable insert sized for inserting into a socket in a dental implant fixture.

According to some embodiments of the invention, the radially expandable insert includes one or more slits axially along the insert for enabling the insert to compress radially when the insert is pushed radially inward.

According to some embodiments of the invention, the radially expandable insert includes at least a portion configured for imparting rotation to a mating portion for accepting imparted rotation in the dental implant fixture.

According to some embodiments of the invention, the portion configured for imparting rotation includes a polygonal radial cross section, corresponding to a polygonal radial cross section of the mating portion for accepting imparted rotation in the dental implant fixture.

According to some embodiments of the invention, the radially expandable insert includes a flange enlarging a distal tip of the radially expandable insert, for engaging with a corresponding ledge in a dental implant fixture.

According to some embodiments of the invention, the radially expandable insert includes an axial hole extending along the insert.

According to some embodiments of the invention, the radially expandable insert further includes threading on the inside of the axial hole, for at least part of the axial hole.

According to some embodiments of the invention, further including a screw threaded for at least part of its length by a thread corresponding to the thread of the insert.

According to some embodiments of the invention, the screw is threaded into the radially expandable insert, the screw prevents the radially expandable insert from compressing radially.

According to some embodiments of the invention, the screw includes a narrowing tip.

According to some embodiments of the invention, an outer surface of at least part of the radially expandable insert is configured to produce a self-locking taper in conjunction with an inner surface of a corresponding a dental implant fixture.

According to some embodiments of the invention, the shank includes a groove for enabling gums to grow over the dental implant fixture.

According to some embodiments of the invention, the dental implant abutment is configured for use as an abutment healing cap.

According to an aspect of some embodiments of the present invention there is provided a bone drill for drilling a hole for a dental implant fixture in a jaw bone including a non-cutting shoulder for limiting a depth of a hole produced by drilling using the bone drill.

According to some embodiments of the invention, the drill includes a conical drilling surface.

According to some embodiments of the invention, the drill includes a drilling surface with a continuously changing angle relative to a longitudinal axis of the bone drill, and wherein the shape of the drilling surface conforms to a shape of a dental implant fixture.

According to some embodiments of the invention, the drill includes a plurality of conical drilling surfaces at different angles relative to a longitudinal axis of the bone drill.

According to an aspect of some embodiments of the present invention there is provided a dental implant drill including a pilot drill configured for being capable of drilling in bone, and a trephine attached concentrically to the pilot drill, wherein a tip of the pilot drill extends more than 5 mm beyond a tip of the trephine and a distance between the trephine and the pilot drill decreases toward a base of the pilot drill.

According to some embodiments of the invention, the distance between the trephine and the pilot drill by an amount between 1 mm and 5 mm.

According to some embodiments of the invention, the trephine includes a single cylindrical blade. According to some embodiments of the invention, the trephine includes a plurality of blades.

According to some embodiments of the invention, the plurality of blades of the trephine includes two blades.

According to some embodiments of the invention, the pilot drill includes a conical pilot drill. According to some embodiments of the invention, the pilot drill includes a plurality of conical drilling surfaces at different angles relative to an axis of the pilot drill.

According to an aspect of some embodiments of the present invention there is provided a kit including a dental implant fixture and an implant carrier as described above. According to some embodiments of the invention, the kit further includes a dental implant abutment.

According to an aspect of some embodiments of the present invention there is provided a kit including a dental implant carrier and a dental implant abutment, both including similarly shaped radially expandable inserts sized for inserting into a socket in a dental implant fixture.

According to some embodiments of the invention, the fit further includes a dental implant fixture including a socket shaped similarly to the radially expandable inserts of the dental implant carrier and the dental implant abutment.

According to an aspect of some embodiments of the present invention there is provided a kit including a dental implant fixture and a dental implant drill including a pilot drill configured for being capable of drilling in bone and a trephine attached concentrically to the pilot drill, the pilot drill is shaped similarly to the dental implant fixture.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings and images. With specific reference now to the drawings and images in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A and 1B are simplified illustrations describing prior art dental implantation;

FIGS. 2A-2C are images of some example moments during performance of dental implantation according to an example embodiment of the invention;

FIGS. 3A-3C are simplified illustrations of a dental implant drill according to some example embodiments of the invention;

FIGS. 4A-4B are simplified illustrations of a bone drill according to some example embodiments of the invention;

FIGS. 5A-5D are simplified illustrations of a top, or proximal, portion of a dental implant fixture according to an example embodiment of the invention;

FIGS. 6A-6B are simplified illustrations of implant carriers according to two example embodiments of the invention;

FIG. 6C is a simplified illustration of a tool for attaching to an implant carrier according to an example embodiment of the invention;

FIGS. 7A-7B are simplified illustrations of a section of a dental implant abutment and a section of a dental implant fixture according to some example embodiments of the invention;

FIG. 7C is a simplified illustration of a dental implant abutment according to an example embodiment of the invention;

FIG. 7D is a simplified illustration of a screw serving to attach a dental implant abutment to a dental implant fixture according to an example embodiment of the invention;

FIGS. 7E-7H are simplified illustrations of the dental implant abutment of FIG. 7C, the screw of FIG. 7D and a dental implant fixture, according to an example embodiment of the invention; and

FIGS. 8A-8B are simplified flow charts describing methods of performing dental implantation according to example embodiments of the invention.

### DESCRIPTION OF SPECIFIC EMBODIMENTS OF THE INVENTION

The present invention, in some embodiments thereof, relates to methods and tooling for dental implant insertion and impression, and more particularly, for methods and tooling for simplified dental implant and to methods and tooling for dental impression.

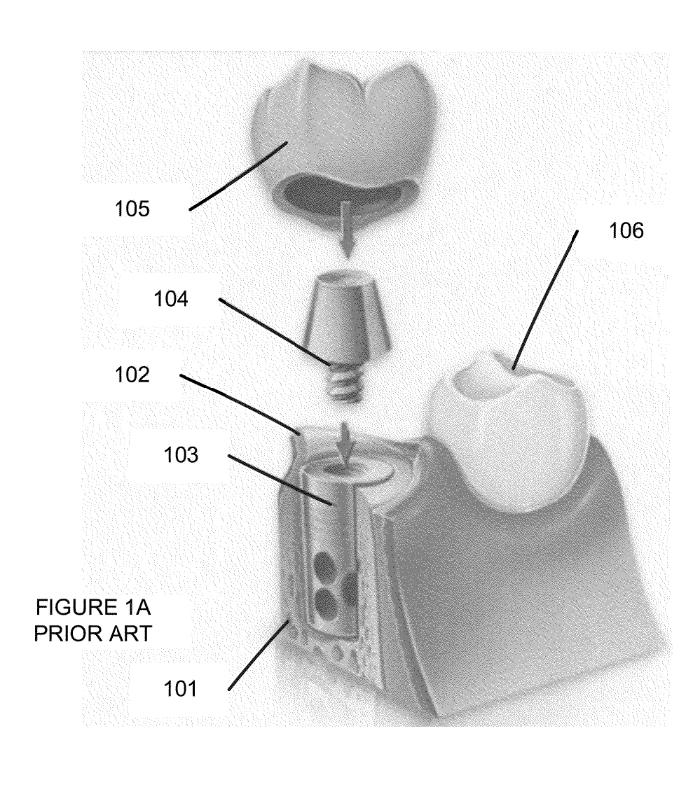

For purpose of better understanding some embodiments of the present invention, reference is first made to FIGS. 1A and 1B, which are simplified illustrations describing prior art dental implantation.

FIG. 1A depicts a jaw bone 101, covered by the gums 102. A typical prior art method of dental implantation includes a first surgical procedure which includes making an incision in the gums 102 over the crest of the site where the implant is to be placed. This is referred to as a ‘flap’. A hole is drilled into the jaw bone 101, and an implant 103 is inserted into the jaw bone. The gums are then sutured, and allowed to heal. The implant 102 is allowed to bond with the bone 101. After the gums have healed, an impression can be made for a crown or a prosthetic tooth 105 which fits in the mouth, next to neighboring teeth, such as tooth 106 of FIG. 1A. Typically, after the implant 103 has bonded with the jaw bone 101, a second surgical procedure is performed, in which an abutment 104 is screwed into the implant 101, serving to connect the implant 101, which serves as a prosthetic root, to the prosthetic tooth 105.

FIG. 1B depicts an implant 112 into which an abutment 114 has been inserted and attached using a screw 117. An implant-abutment contact area 118 is also depicted.

It is noted that when the abutment 114 is attached to the implant 112 by the screw 117, according to this prior art technique, the design of the implant 112, abutment 114 and screw 117 assembly defines where the implant-abutment contact area 118 occurs, and that this is a load-bearing surface for supporting the pressure caused by biting on prosthetic tooth or crown. The area is not large, and if it is made larger, the pressure is spread over a larger area and the implant 112, abutment 114 and screw 117 components will withstand the pressure better.

It is also noted that the screw 117 has its threads deep inside the implant 112, and if the screw 117 breaks in the implant 112, a dental practitioner faces a daunting task of extracting a part of the screw 117 from deep down inside the implant 112.

It is noted that the screw 117 typically breaks at a point 119 where the abutment 114 ends. Getting the broken end of the screw out from an implant which is in the jaw is a daunting task.

Recent statistics of dental implants shows that up to 50% of dental implant practitioners see cases of broken screws.

It is noted that some screws 117 become loose over time. During attachment of the abutment 114 to the implant 112 the screw is tightened, for example at a torque of 30 Newton-meters. Too high a torque may break the implant 112 bond to the bone. Too low a torque may have the screw 117 become loose sooner. Forces which act on the implant-abutment contact area 118 eventually crush the implant-abutment contact area 118, and potentially relax a tension of the screwed-tight screw 117 to a point where the screw 117 becomes loose, requiring a practitioner to retighten the screw.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The majority of dental implants inserted today are still being implanted by dental surgeon and periodontists. Recent scientific literature suggest that implants that have been installed under conditions of standard dental operations by people who are not dental surgical experts have the same success rate as done with dental surgeon experts.

The aim of some embodiments of the invention is to create a method of dental implant insertion that simplifies the procedure, provides tooling to perform the implant insertion procedure with minimal surgical involvement, and provides an opportunity to take an impression for prosthesis production during a first insertion appointment.

A simplified impression procedure performed immediately after the implant insertion will also be described. The tools to achieve a simplified impression are described.

The simplified implant insertion and impression method and tools aim to minimize the surgical aspect of the implant insertion procedure; shorten the time of the procedure, and potentially cause minimal post procedure pain and discomfort. As a result the process will enable the general practitioner dentist to perform the implant insertion procedure, as the procedure will not include with incision and suturing which are surgical procedures by nature.

An aspect of some embodiments of the invention is to provide a method for drilling a hole in bone for an implant fixture and simultaneously drilling/punching a hole in gum tissue. In some embodiments the drilling is done by using a drill which has a central pilot drill to drill through gum tissue into bone, and a trephine (a drill which cuts out a shape of a circle) to cut a larger circle of gum tissue surround the hole in the bone. The simultaneous drilling allows a practitioner to center the pilot drill, and enjoy a benefit of cutting the gums in an approximate area where a dental prosthesis will come. The cutting of the gums removes some gum tissue which is to be removed, in contrast with a prior art technique which cuts a flap of gum tissue, pulls the flap aside to uncover a jaw bone for drilling, then pulls the flap back and sutures the flap after drilling the bone.

An aspect of some embodiments of the invention is to provide a method to take an impression for a dental prosthesis for attaching to an implant in the same procedure as the above-mentioned drilling The gum tissue removed is typically from a volume which would be replaced by the dental prosthesis which is intended to be used at the site. In some embodiments an impression of the environment of the implant may be made at the site of the drilling, close after the drilling, even during the same procedure, since the gums are not disfigured by an incision for a flap and by sutures for closing the flap.

An aspect of some embodiments of the invention is to provide a dental implant carrier which can serve for carrying a dental implant fixture and also for taking an impression as mentioned above. In some embodiments the dental implant carrier is attached to a socket in the dental implant, and at least part of the shape of the dental implant carrier is made similar to a shape of an abutment planned to be attached to the implant when the dental prosthesis will be attached to the implant. When an impression of the dental site is taken, the impression material records a volume and shape which already includes the correct shape for the planned abutment. In some embodiments, the impression material is removed together with the dental implant carrier, and the implant may be covered with a healing cup. In some embodiments, the healing cup has a connector of a same shape as the connector of the implant carrier. In some embodiments, an implant carrier is not user, but a stub is attached to the implant to make the impression, with the shape of the planned abutment, at least in the volume of the impression material. In some embodiments, the stub has a connector of a same shape as the connector of the implant carrier.

The implant carrier can have a head suitable for attaching a tool, so the tool can serve to rotate the implant carrier, and the implant carrier can rotate the implant, while inserting the implant into bone. A section in the implant carrier which is inserted into a socket in the implant can have a rotation-transferring shape, such as a hexagonal insert into a hexagonal recess.

An aspect of some embodiments of the invention is to provide a dental implant carrier which can serve as a healing cap, and/or to provide a healing cap with a same insert for attaching to a dental fixture socket as the above-mentioned dental implant carrier, to replace the dental implant carrier in the dental fixture socket.

An aspect of some embodiments of the invention is to provide a dental implant abutment with a same insert for attaching to a dental fixture socket as the above-mentioned dental implant carrier.

An aspect of some embodiments of the invention is to provide a dental implant abutment and a screw for attaching the abutment to a dental fixture so as to have the screw within the abutment, to prevent breakage of the screw in the fixture.

An aspect of some embodiments of the invention is to provide a dental implant abutment and a screw for attaching the abutment to a dental fixture without tensioning the screw, but by pushing part of the abutment against the fixture, locking the abutment and the fixture together.

An aspect of some embodiments of the invention is to provide a dental implant fixture which has a socket suitable for accepting the above-mentioned dental implant carrier and/or the above-mentioned healing cap and/or the above mentioned dental implant abutment.

In some embodiments, during the implant insertion appointment, the possibility to take the implant positioning impression for the prosthesis is provided. This procedure is typically not strictly part of a dental surgeon's or periodontist's routine, and is more in the nature of work of a general dental practitioner.

According to some embodiments of the present invention, implanting a dental fixture and taking an impression of a crown or a prosthetic tooth for a dental crown or prosthetic tooth are performed in one procedure. A method for so doing is described herein. Dental implant components and tooling which potentially aid in the procedure and/or potentially improve the quality and increase the lifetime of a dental implant are also described herein.

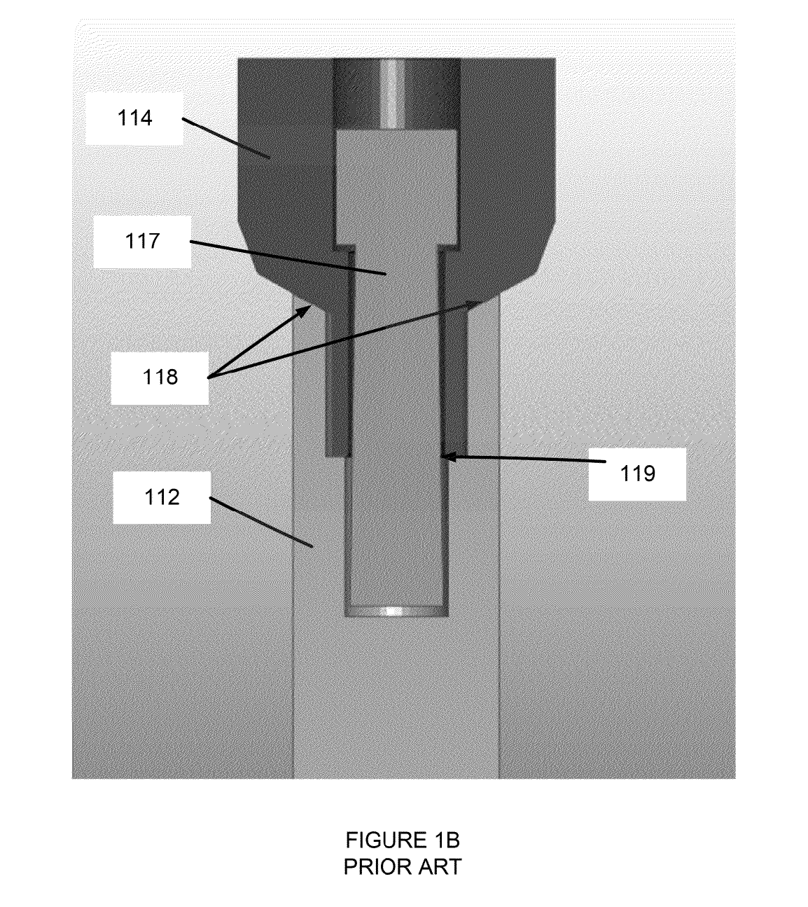

Reference is now made to FIGS. 2A-2C, which are images of some example moments during performance of dental implantation according to an example embodiment of the invention.

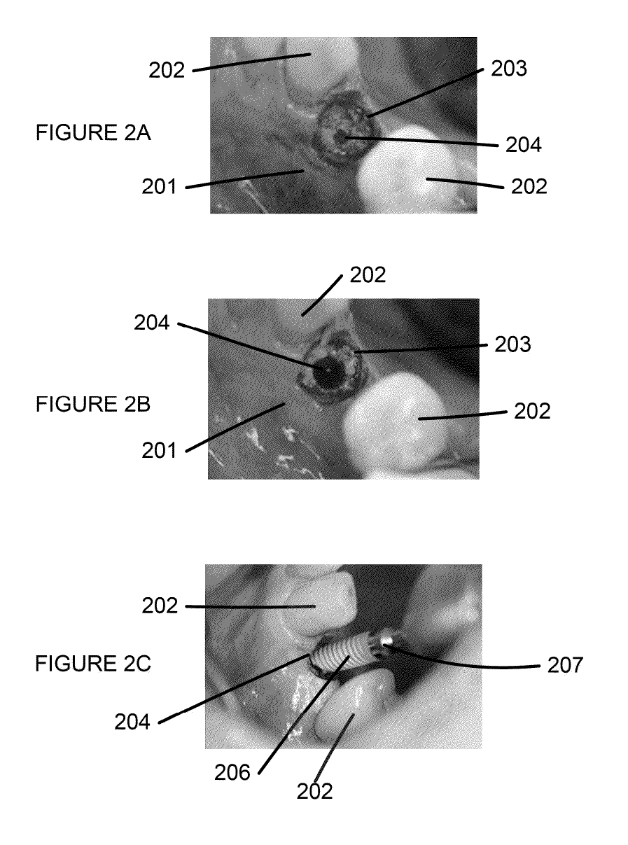

FIG. 2A depicts an image of a jaw 201 with a tooth absent between two teeth 202. A dental practitioner has drilled through gum tissue and bone, using a dental implant drill according to an example embodiment of the invention. The drilling through gum tissue and bone has optionally been performed in one drilling motion, with a pilot drill drilling a central hole 204 into gum overlaying the bone and into the bone itself, and a trephine attached concentrically to the pilot drill drilling a larger concentric hole 203 into the gums. The drilling for FIG. 2A may optionally be performed by dental implant drills such as depicted in FIGS. 3A-3D.

In some embodiments, the larger concentric hole has a diameter approximately 0.5-2 mm larger than a diameter of a dental implant fixture planned to be implanted.

FIG. 2B depicts the jaw 201 with the central hole 204 of FIG. 2A.

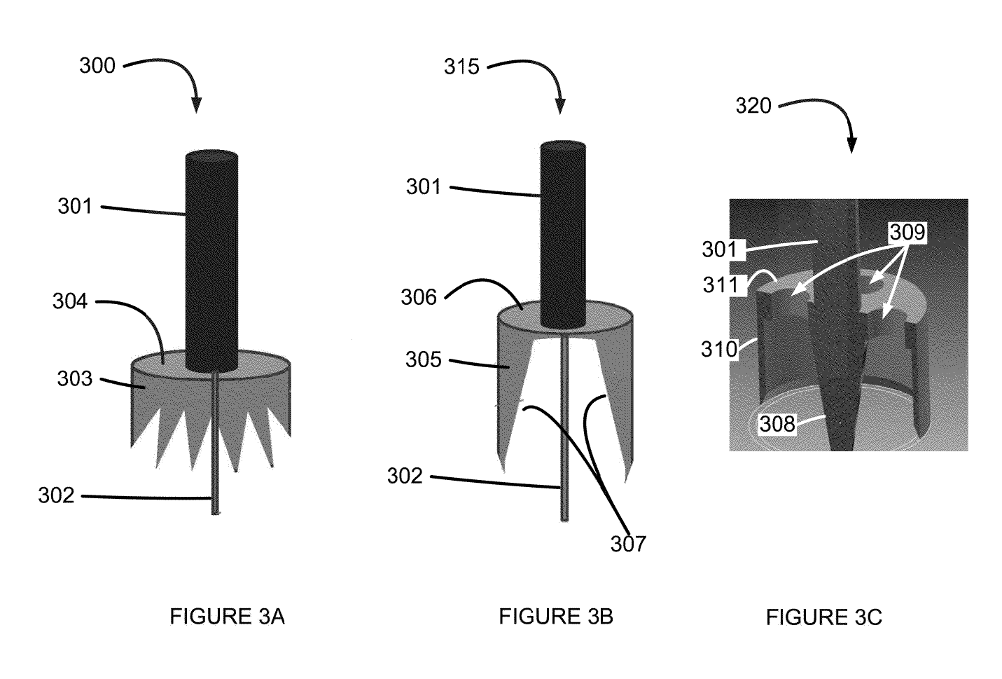

In some embodiments, the central hole 204 is optionally enlarged by drilling with a bone drill (not shown, optionally a bone drill such as depicted in FIGS. 4A and 4B) suitable for inserting a dental implant fixture which requires a hole of a size greater than the central hole 204.

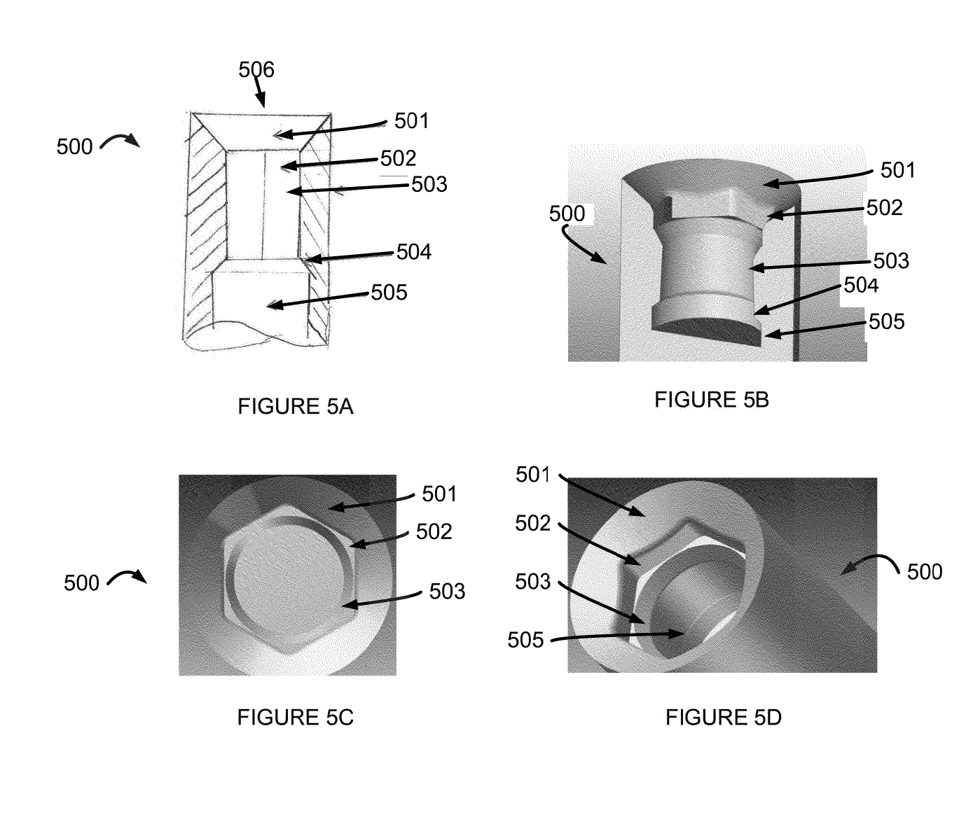

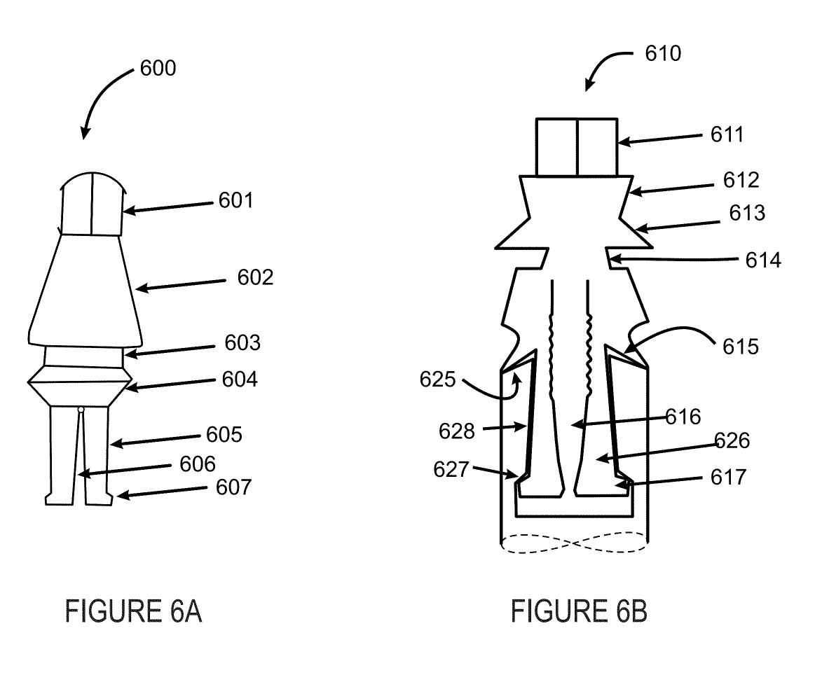

FIG. 2C depicts the jaw 201, and a dental implant fixture 206 being inserted into the hole 204. The dental implant fixture 206 is optionally attached to an implant carrier (not shown, optionally an implant carrier such as depicted in FIGS. 6A and 6B), which is optionally attached to a mandrel 207 configured to provide rotation to the dental implant fixture 206 via the optional implant carrier.

When the hole 204 is ready, the dental implant fixture 206 is optionally removed from a sterile package and mounted on an insertion tool (not shown, optionally a tool such as depicted in FIG. 6C, optionally via an implant carrier such as depicted in FIGS. 6A and 6B), which is optionally connected to a contra angle motor optionally configured to provide rotation of the tool while controlling torque and speed. The control of torque and speed by the motor applying the rotation is optionally performed electronically, by a computerized system. The control system, during the drilling process, optionally detects torque and optionally reduces rotational speed automatically to avoid heating the bone.

The dental implant fixture 206 may optionally be delivered by the dental practitioner to the prepared hole 204 in the bone. The dental practitioner optionally locates a tip of the dental implant fixture 206 in the hole 204, and operates the motor to screw in the implant following the tip, The motor optionally rotates the implant, optionally between a quarter of a turn to 5 turns or more, and the dental implant fixture 206 is optionally screwed into the hole 204.

In some embodiments, the hole 204 has a conical shape, being broader at the top, tapering toward its depth, and the dental implant fixture 206 also optionally has a conical shape corresponding to the shape of the hole 204.

In some embodiments the control system attached to the dental implant fixture 206 optionally computes the torque needed to perform the insertion, and translates the torque to control messages to the motor.

When the dental implant fixture 206 is in position, the insertion tool is disconnected from the implant carrier. The implant carrier optionally stays attached to the dental implant fixture 206, and now optionally functions to provide a shape to be taken for impression.

The dental practitioner optionally pours impression material in an impression tray, and optionally inserts the tray with the impression material onto an area surrounding the implant and surrounding tissues, known as a transfer area. When the impression material sets, the impression material is optionally taken out of the mouth. The impression material has captured the shape of the transfer area, and also of the top of (head and shank) of the implant carrier, which top is shaped similarly to a shape of a top (head and shank) of an abutment planned to be attached to the dental implant fixture 206.

In some embodiments, the removal of the impression material does not detach the implant carrier from the dental implant fixture 206.

In some embodiments, the implant carrier is not removed with the impression material, and is optionally left to function as a healing abutment.

In some embodiments, the implant carrier may optionally be detached from the dental implant fixture.

In some embodiments, the removal of the impression material pulls on the implant carrier and detaches the implant carrier from the dental implant fixture 206.

In some embodiments, the impression is optionally sent to a dental laboratory for manufacturing a dental prosthesis to be attached to the dental implant fixture 206, optionally via an abutment. In some embodiments, the implant carrier remains with the impression sent to the dental laboratory.

In some embodiments the implant abutment area is optionally sealed by what is known in the art as a healing cup abutment.

Some considerations and potential advantages associated with taking an impression at a same stage as performing implant of the dental implant fixture are:

1) The implant is already in its fixed location.

2) The impression material can reach to the bone level and the dental practitioner can have the impression at this early time.

3) There is no need for an implant exposure appointment.

4) There is no need for an impression appointment.

The above-described example of the implant dental implant fixture insertion avoids the necessity of a surgical incision, opening a just-sufficient area of the oral mucosae, over the implant insertion point, which is minimal in order to potentially avoid contact of the oral mucosae with the inserted implant during the insertion act.

Some considerations and potential advantages associated with the above-described implant procedure and impression procedure are:

1) Steps in the procedure are designed to lay the ground for the next step.

2) The implant insertion process does not require performing a surgical incision and does not require suturing.

3) Lower post-operative discomfort.

4) Does not require a second stage implant exposure.

5) Saves time.

It is noted that the tooling and components described herein are contemplated for production of any biocompatible material, of which an example can be a compound of titanium named Ti6a14va.

It is noted that the tooling and components described herein, and in some embodiments at least the dental implant abutment, are contemplated for optional coating by an antibacterial coating such as a Vancomycin coating, and/or a magnetic polymer coating, and/or an antibacterial metal coating.

Reference is now made to FIGS. 3A-3C, which are simplified illustrations of a dental implant drill according to some example embodiments of the invention.

FIGS. 3A-3C are example embodiments of drills which can produce the central hole 204 and the concentric hole 203 depicted in FIGS. 2A and 2B.

FIG. 3A depicts a drill 300 having a drill shank 301, a pilot drill 302 configured for being capable of drilling in bone, and a trephine 303 attached concentrically to the pilot drill 302.

A trephine is a surgical instrument with a cylindrical blade. It can be of one of several dimensions and designs depending on what it is going to be used for. A trephine may be specially designed for obtaining a cylindrically shaped core.

FIG. 3A depicts a trephine 303 with multiple blades.

In some embodiments, the trephine 303 has 2-20 blades.

In some embodiments, the trephine 303 has a diameter ranging from 3-5 mm.

In some embodiments, the pilot drill 202 extends from 1-10 mm beyond a circle defined by tips of the trephine 303 blades.

In some embodiments, the pilot drill 302 has a diameter ranging from 0.5-3 mm.

It is noted that the trephine 303 is attached to the drill shank 301 by a shoulder 304. The shoulder 304 optionally limits the depth which the trephine 303 can drill in the gums.

In some embodiments, a drill size is selected so that the trephine 303 can drill down to bone, and that the shoulder 304 does not prevent from drilling down to bone.

FIG. 3B depicts a drill 315 having the drill shank 301, the pilot drill 302, a trephine 305 and trephine shoulder 306.

The drill depicted in FIG. 3B has two blades 307.

The drill depicted in FIG. 3B has blades 307 which are thicker toward their base, defining a space between the blades 307 and the pilot drill 302 which gets narrower toward the top.

In some embodiments, the thickness of the blades 307 ranges from 0.5-1.75.

The narrowing space for tissue which is excised from the gums, between the pilot drill and the blades, potentially assists in capturing and retracting the soft tissue.

FIG. 3C depicts a drill 320 having the drill shank 301, a pilot drill 308, a trephine 310 and a trephine shoulder 311.

In some embodiments, as depicted in FIG. 3C, the pilot drill 308 has a conical shape.

In some embodiments, the pilot drill 308 has a conical shape which is used to drill a hole sufficient for implanting the dental implant fixture 206 of FIG. 2C, without requiring a widening of a pilot hole drilled by the pilot drill 308.

In some embodiments, as depicted in FIG. 3C, the trephine 310 has a single cylindrical blade.

In some embodiments, as depicted in FIG. 3C, the trephine shoulder 311 has holes 309.

In some embodiments, the holes 309 may be used by a practitioner during a drilling procedure, to pull out tissue from inside the trephine 310, preferably while the trephine is not rotating.

The drills of FIGS. 3A-3C are optionally used to punch the gingivae over a targeted implant location, in a diameter optionally larger than the diameter of the implant. Such a procedure is optionally performed with a trephine and a central pilot drill. The pilot drill optional functions as a pivot which centralizes and locates the trephine drill. The pivot facilitates the punch action—the trephine knives cut the oral mucosae by rotation, producing a punching procedure.

In some embodiments the trephine is designed to be narrower in a direction opposite to the punching aspect of the trephine. Such a design potentially captures and contains the punched oral mucosae in the internal volume of the trephine and detaches the mucosae from the bone.

The pilot dill optionally has an additional function. After the gingivae over an implant location has been removed with the trephine drill, the bore hole in the exposed bone drilled by the pilot drill is designed to locate and pivot a pilot drill as part of the drill 400 described with reference to element 405 of FIG. 4A, and to guide the drill 400 to the optional continuation of an incremental conical drilling process to obtain a bore hole which fits a dental implant shape and diameter.

For the purpose of bore hole preparation, in some cases the process may require more than one step, depending on the size of the implant and the density of the bone. Optionally, the following steps will be conducted in a similar method, with a prior drill leaving a pilot hole for a successive drill. The steps are designed to facilitate the drilling process by centralizing and pivoting the successive drill.

The depth of the bore hole is optionally limited by a non-cutting extension shoulder, above the largest active drill diameter. The non-cutting extension is optionally located in a position on the drill to achieve a bore hole length in accordance with a desired implant.

Reference is now made to FIGS. 4A-4B, which are simplified illustrations of a bone drill 400 according to some example embodiments of the invention.

FIG. 4A depicts a drill 400 having a shank 401, cutting/drilling surfaces 402 404 405, and optionally a depth-limiting non-cutting shoulder 403.

In some embodiments the drill 400 has a single cutting/drilling surface, that is, a cutting/drilling surface without steps such as depicted between the cutting/drilling surfaces 402 404 405. In some embodiments the single cutting/drilling surface has a fixed angle. In some embodiments the single cutting/drilling surface has a gradually tapering tip with changing angles (not shown), even continuously changing angles (not shown), optionally corresponding to a shape of a dental implant fixture 206.

In some embodiments the cutting/drilling surface 405, being the narrowest portion of the drill, acts as a pilot drill for the rest of the drill 400.

In some embodiments the cutting/drilling surfaces have different angles, as depicted in FIG. 4A.

In some embodiments, as depicted in FIG. 4A, the depth-limiting non-cutting shoulder 403 limits the depth to which the drill 400 can drill.

FIG. 4B depicts a drill 410 having a shank 401, cutting/drilling surfaces 406, and optionally a depth-limiting non-cutting shoulder 403.

In some embodiments the drill 410 has multiple cutting/drilling surfaces 406, forming a drill having different diameters in several steps.

It is noted that the shape of the cutting/drilling surfaces 402 404 405 in FIG. 4A and the cutting/drilling surfaces 406 in FIG. 4B is intended to schematically illustrate shapes for a cutting drill, while many shapes are contemplated.

In some embodiments the shape of the drill of FIGS. 4A and 4B, and/or the pilot drills 302 308 conforms to an outer shape of the implant fixture intended for the hole which the drills are shaped to drill.

In some embodiments the narrowest tip of the drills 400 410 has a diameter in a range between 0.75-2.5 mm. The diameters of additional drilling/cutting surfaces optionally range between 2.5-5 mm.

In some embodiments a length of the drilling/cutting portions of the drill extends between 5-15 mm.

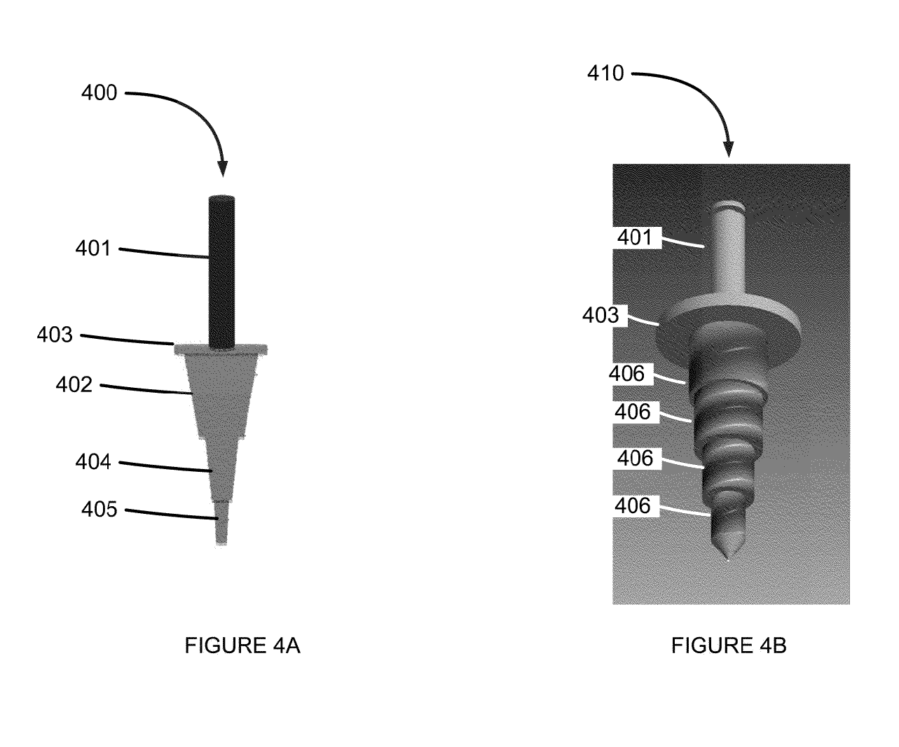

Reference is now made to FIGS. 5A-5D, which are simplified illustrations of a top, or proximal, portion of a dental implant fixture 500 according to an example embodiment of the invention.

FIG. 5A depicts a cross section of the top portion of the dental implant fixture 500, having a socket 506. The socket 506 has an inclined shoulder 501, continuing with a polygonal cross-section 502 (optionally hexagonal), optionally continuing with a smooth section 503, having a section 505 with a larger diameter, optionally with a shoulder 504 between the larger diameter section 505 and the top of the socket 506.

The polygonal cross-section 502 enables using a corresponding polygonal tool to optionally rotate the dental implant fixture 500 while inserting the dental implant fixture 500 into bone.

The top portion of the dental implant fixture 500 is shaped so as to connect with an implant carrier during insertion of an implant fixture, and with an abutment when the prosthesis is mounted on the implant fixture.

In some embodiments the connection benefits from an increased contact area between an abutment and the dental implant fixture 500, by virtue of inclined shoulders 501 and 504, relative to the contact area 118 of FIG. 1B.

It is noted that the increased contact area also potentially acts as an increased area where the contacting surfaces seal the inside of the dental implant fixture 500 from the mouth environment. It is noted that if material enters the inside of the dental implant fixture 500, by virtue of a bad seal, the material may rot and induce a bad taste in the mouth.

In some embodiments, an outer diameter of the top of the dental implant fixture 500 is in a range of 2.5-5 mm.

In some embodiments, the polygonal cross-section 502 (optionally hexagonal), conforms to an abutment and/or implant-carrier outer surface, optionally having a diameter of 1.25-3.5 mm.

In some embodiments, the shoulder 504 is an undercut incline.

FIG. 5B is a side isometric view of the dental implant fixture 500.

FIG. 5C is a top isometric view of the dental implant fixture 500.

FIG. 5D is an isometric view of the dental implant fixture 500.

Reference is now made to FIGS. 6A and 6B, which are simplified illustrations of implant carriers 600 610 according to two example embodiments of the invention.

The implant carriers are used for carrying implant fixtures to a bore hole in a bone and inserting the implant fixtures, as well as also optionally used for impression taking for dental prosthesis.

FIG. 6A depicts a first example embodiment of an implant carrier 600.

The implant carrier 600 includes:

a polygonal shaped head 601 (optionally hexagonal);

a shank 602, optionally of a shape and length designed for taking an impression for a shank of an abutment which will eventually be used to attach to an implant fixture which the implant carrier is designed to carry;

a narrowing of the shank, or a groove 603, for accepting of impression material when an impression is taken;

a contact area 604, corresponding to a contact area in a corresponding implant fixture;

an insert 605 section which is configured to enter into a corresponding socket in the corresponding implant fixture;

a shoulder 607, designed to be broader than the above-mentioned socket in the corresponding implant fixture, designed to expand into a broadening in the corresponding implant fixture; and

slits 606 in the insert 605, to allow the insert 605 to compress when passing through the above-mentioned socket in the corresponding implant fixture, before expanding back and latching onto the broadening in the corresponding implant fixture.

In some embodiments the polygonal shaped head 601 is a hex head with a diameter in the range of 1.25-2.5 mm, designed to optionally be attached to a mandrel with a corresponding inner hex, optionally on a contra angle motor of a physiodispenser.

In some embodiments the shank 602 length is in a range approximately between 3-12 mm, according to a desired space for an impression in the oral cavity.

In some embodiments the groove 603 under the shank 602 is designed to conform to a design of an implant abutment connection area.

In some embodiments the insert 605 has a cross-section of a polygonal shape, optionally a hexagonal shape.

The number of splits 606 may be one, two or more, to fulfill a purpose of allowing the insert to compress in a spring-like action to facilitate inserting and extracting the implant carrier 600 to and from the implant fixture during the implant fixture insertion and during the impression taking phase.

FIG. 6B depicts a second example embodiment of an implant carrier 610, inserted into a socket in a dental implant fixture 628.

The implant carrier 600 includes:

a polygonal shaped head 611 (optionally hexagonal);

a shank 612 613, optionally of a shape and length designed for taking an impression for a shank of an abutment which will eventually be used to attach to an implant fixture which the implant carrier is designed to carry;

a narrowing of the shank, or a groove 614, for accepting of impression material when an impression is taken;

a contact area 615, corresponding to a contact area 625 in the corresponding implant fixture 628;

an insert 626 section which is configured to enter into a corresponding socket in the corresponding implant fixture 628;

a shoulder 617, designed to be broader than at least some of the cross-section area of the above-mentioned socket in the corresponding implant fixture 628, designed to expand into a broadening in the corresponding implant fixture 628; and

one or more slits 616 in the insert 626, to allow the insert 626 to compress when passing through the above-mentioned socket in the corresponding implant fixture 628, before expanding back and latching onto the broadening in the corresponding implant fixture 628.

In some embodiments the groove 614 under the shank 612 613 is designed to conform to a design of an implant abutment connection area.

The number of splits 616 may be one, two or more, to fulfill a purpose of allowing the insert to compress in a spring-like action to facilitate inserting and extracting the implant carrier 610 to and from the implant fixture during the implant fixture insertion and during the impression taking phase.

In some embodiments, the angle of the outer surface of the insert 626 is at a small, acute angle relative to a longitudinal axis of the insert 626, and the angle of an inner surface of the socket (such as the socket 506 of FIG. 5A) of the dental implant fixture 628 is also at a small, acute angle relative to a longitudinal axis of the socket, such that the two surfaces are parallel to each other when the insert 626 of the dental implant carrier 610 is inserted into the dental implant fixture 628.

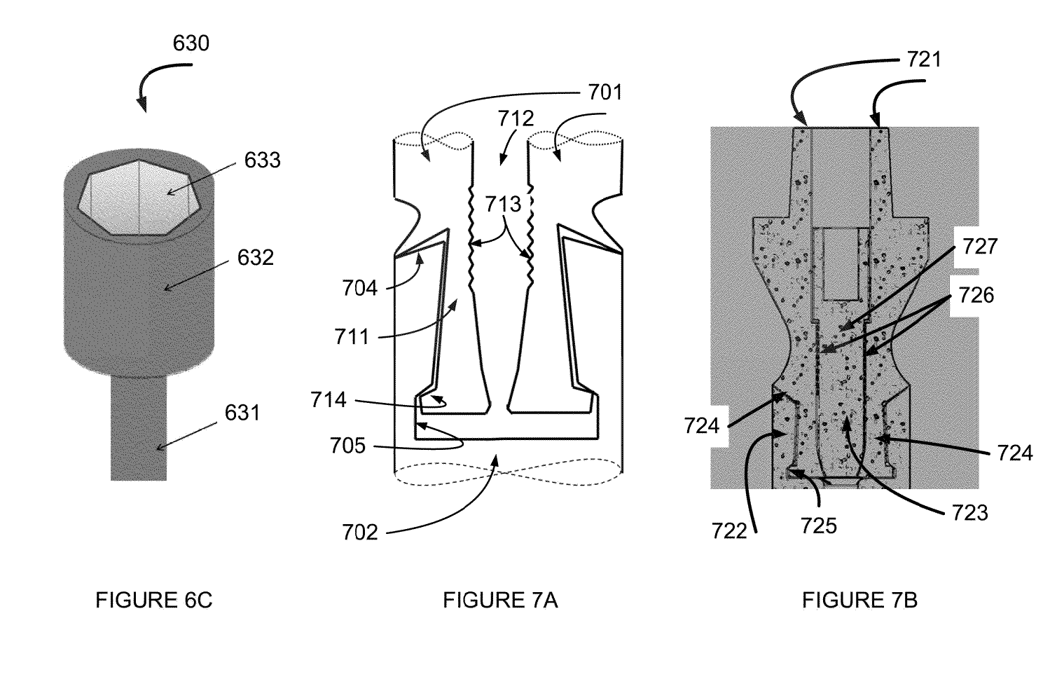

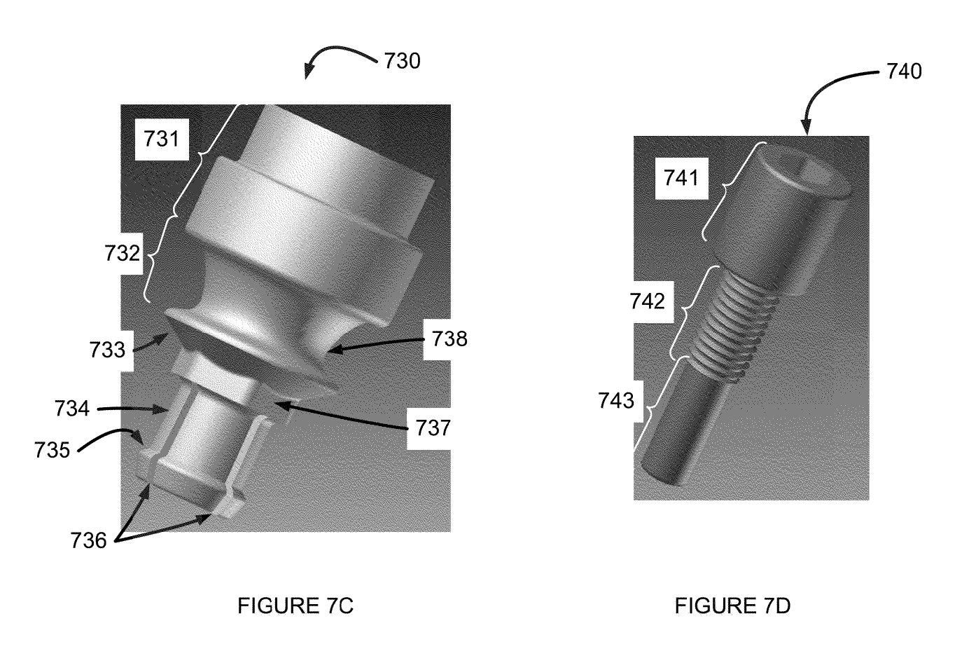

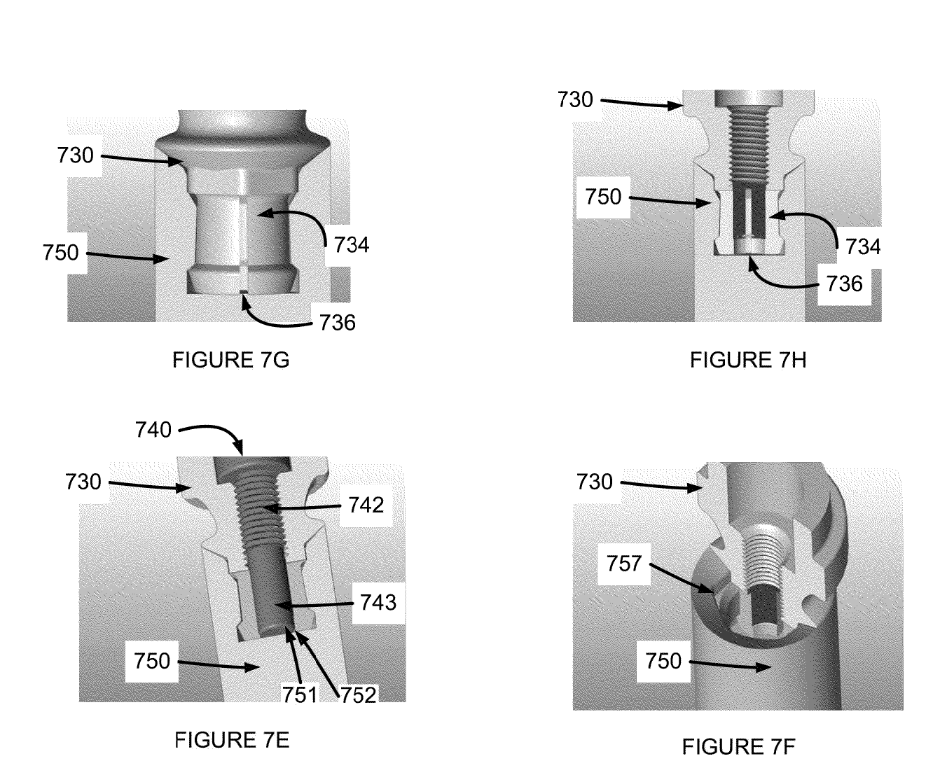

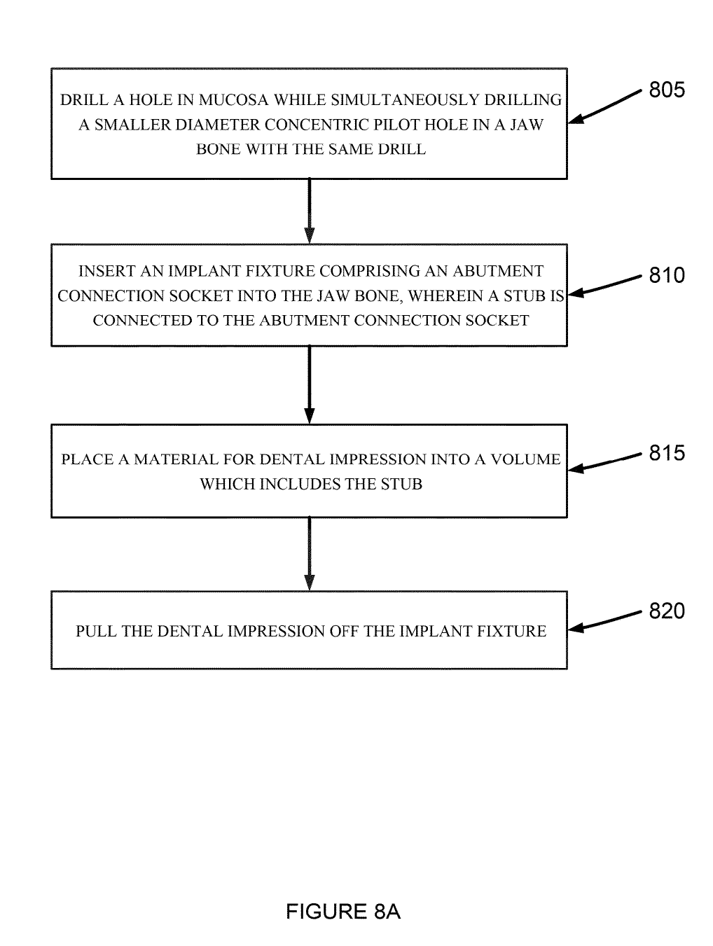

In some embodiments, the two small acute angles form what is termed a self-holding taper, such as a Morse taper. The self-locking taper potentially locks the above-mentioned surfaces especially tight to each other, as is further described below with reference to FIG. 7A.

It is noted that the above description of a dental implant carrier 610 may also apply to a dental abutment healing cap. A dental abutment healing cap is a cap inserted into the socket of the dental implant fixture, optionally used, for example, while the gums heal and/or while waiting for a dental prosthesis or crown to be made.

In some embodiment a dental abutment healing cap is provided which has at least some of the features described above with reference to the dental implant abutment in FIGS. 6A and 6B.

Reference is now made to FIG. 6C, which is a simplified illustration of a tool 630 for attaching to an implant carrier according to an example embodiment of the invention.

The tool 630 includes a shank 631, a mandrel 632, and a polygonal hole 633 corresponding to a polygonal head of an implant carrier head.

Reference is now made to FIGS. 7A-7B, which are simplified illustrations of a section of a dental implant abutment 701 and a section of a dental implant fixture 702 according to some example embodiments of the invention.

FIG. 7A depicts the dental implant fixture 702 with a contact area 704 for the dental implant abutment 701 to press against, and with a groove 705 for the dental implant abutment 701 insert 711 to latch onto.

The dental implant abutment 701 has a hole 712 extending through the middle, and has a threaded section 713 in the hole 712, into which a screw is designed to fit.

The dental implant abutment 701 also has a ledge 714 designed to make a contact area with the groove 705 of the dental implant fixture 702.

In some embodiments, when a screw is inserted into the hole 712, it pushes the insert 711 aside, and the angle on the ledge 714 pulls the dental implant abutment 701, tightening contact between the dental implant abutment 701 and the dental implant fixture 702 at the contact area 704.

It is noted that the threaded section 713 of the dental implant abutment 701 is in a relatively high section of the dental implant abutment 701, so if the screw breaks at the thread, as it does when the screw breaks at all, then the screw is broken inside the dental implant abutment 701, and not deep inside the dental implant fixture 702, as would happen in the case of the screw 117 of prior art FIG. 1B.

It is also noted that the screw is designed to press outward against the dental implant abutment 701, to keep the ledge 714 against the groove 705, and seal a contact area between the two.

It is noted that the when the screw is screwed in, the screw is designed to press outward against the dental implant abutment 701, and lock the dental implant abutment 701 into the socket of the dental implant fixture 702. The locking potentially happens with much lower torque than the 30 Newton-meter mentioned above with reference to a prior art configuration depicted in FIG. 2B.

In some embodiments, the angle of the outer surface of the insert 711 is at a small, acute angle relative to a longitudinal axis of the insert 711, and the angle of an inner surface of the socket (such as the socket 506 of FIG. 5A) of the dental implant fixture 702 is also at a small, acute angle relative to a longitudinal axis of the socket, such that the two surfaces are parallel to each other when the insert 711 of the dental implant abutment 701 is inserted into the dental implant fixture 702.

In some embodiments, the two small acute angles form what is termed a self-holding taper, such as a Morse taper. The self-locking taper potentially locks the above-mentioned surfaces especially tight to each other, forming both a seal between the surfaces and a broad contact area of support for the dental implant abutment 701.

In some embodiments, the angle for forming the self-holding taper is in a range from 1 degree 30 minutes to 2 degrees 50 minutes of arc.

It is noted that an additional benefit is that the dental implant abutment 701 presses back against the screw, and makes it more unlikely than in prior art cases such as depicted in FIG. 1B that the screw would work its way loose.

FIG. 7B depicts a dental implant fixture 722 with a contact area 724 for the dental implant abutment 721 to press against, and with a groove 725 for the dental implant abutment 721 insert 724 to latch onto.

A threaded section 726 in the dental implant abutment 721 is higher up, relative to FIG. 7A, and is completely within the dental implant abutment 721 and not within the dental implant fixture 722.

A screw 727 is depicted, optionally with a tapered tip, pushing the sides of the dental implant abutment 721 and locking the dental implant abutment 721 within the dental implant fixture 722.

In some embodiments the contact area 724 is produced with an inward-directing angle, for example between 30 and 60 degrees, which aids a practitioner in inserting the dental implant abutment 721 into the dental implant fixture 722.

Reference is now made to FIG. 7C, which is a simplified illustration of a dental implant abutment 730 according to an example embodiment of the invention.

FIG. 7C depicts an isometric view of an outside of an example embodiment of the dental implant abutment 730.

FIG. 7C depicts:

a head 731;

a shank 732, optionally of a shape and length designed for attaching a dental prosthesis to an implant fixture;

a contact area 733, corresponding to a contact area in a corresponding implant fixture;

an insert 734 section which is configured to enter into a corresponding socket in the corresponding implant fixture;

a shoulder 735, designed to latch into a groove in the corresponding implant fixture; and

slits 736 in the insert 734, to allow the insert 734 to compress when passing through a socket in the corresponding implant fixture, before expanding back and latching onto a broadening in the corresponding implant fixture.

In some embodiments at least a portion 737 of the insert 734 has a polygonal cross-section, such as a hexagonal cross section, as is depicted in FIG. 7C. The polygonal cross-section of the section 737 is intended to correspond to a mating polygonal cross section in a corresponding implant fixture, and to prevent the dental implant abutment 730 from rotating within the implant fixture.

In some embodiments, the shank 732 dental implant abutment 730 optionally has a groove 738, similar to the depiction in FIG. 7C, for enabling the gums to grow close to and even slightly over the dental implant fixture (not shown) into which the dental implant abutment 730 is placed.

Reference is now made to FIG. 7D, which is a simplified illustration of a screw 740 serving to attach a dental implant abutment to a dental implant fixture according to an example embodiment of the invention.

The screw 740 has three sections, a head 741, a threaded section 742 and an extension 743 without threads.

In some embodiments the threaded section 742 of the screw 740 does not suffer from pressure from the dental prosthesis, such as biting pressure. The threaded section 742 keeps the extension 743 of the screw 740 in an insert 734 of the dental implant abutment 730, which keeps the dental implant abutment 730 pressing against the dental implant fixture. Biting pressure passes from the dental implant abutment 730 to the dental implant fixture via the above-mentioned contact areas, optionally without passing through the screw 740.

In some embodiments the threaded section 742 is shorter than the unthreaded extension 743.

In some embodiments, a different type of screw (not shown) is provided, which has an extension of a smaller diameter than the screw 740 depicted in FIG. 7D. The different screw can optionally serve for extracting a dental implant abutment 730 from a socket in a dental implant fixture such as the dental implant fixture 722 of FIG. 7B. When the different screw is screwed, the extension of the screw contacts a bottom of the socket of the dental implant fixture 722, and exerts force upward on the thread of the dental implant abutment 730. The narrow extension of the different screw is designed to be of a small enough diameter so as not to push the sides of the insert of the dental implant abutment 730 sideways, so the insert does not lock the dental implant abutment 730 into the socket of the dental implant fixture 722.

Reference is now made to FIGS. 7E-7K, which are simplified illustrations of the dental implant abutment 730 of FIG. 7C, the screw 740 of FIG. 7D and a dental implant fixture 750, according to an example embodiment of the invention.

FIG. 7E is a side isometric view of a cross section of the dental implant abutment 730, the screw 740 and the dental implant fixture 750, showing the screw 740 having its extension in the dental implant fixture 750 and its threads in the dental implant abutment 730.

FIG. 7E depicts an optional feature, which may be used in some embodiments. The screw 742 optionally has a taper near its tip 751, and the dental implant abutment 730 optionally has an inside ledge near its tip 752, such that tightening the screw potentially pushes the sides of the insert 734 of the dental implant abutment 730 sideways.

In some embodiments, the tip of the screw 740 can produce a seal with the bottom of the socket of the dental implant fixture 750. The dental implant fixture 750 is optionally provided with an axial hole from the socket to the tip (not shown). The axial hole (not shown) optionally serves to insert, optionally by a syringe, bone graft material through the dental implant fixture 750, for example to build more supportive bone, for example in a sinus in an upper jaw. After inserting the bone graft material, the screw 740 seals the opening in the dental implant fixture 750, preventing bacterial migration from the oral cavity into the location of the bone graft.

FIG. 7F is an isometric view of a cross section of the dental implant abutment 730 and an isometric view of the dental implant fixture 750, showing the relative location of the dental implant abutment 730 and the dental implant fixture 750 to each other, and showing the polygonal shape of a section of the dental implant fixture 750.

FIG. 7G is a side view of a cross section of the dental implant fixture 750 and a side isometric view of the dental implant abutment 730, showing a slit 736 of the insert 734 of the dental implant abutment 730.

FIG. 7H is a side view of a cross section of the dental implant fixture 750 and a side view of a cross section of the dental implant abutment 730, showing a slit 736 of the insert 734 of the dental implant abutment 730.

In some embodiments an implant fixture and a double function implant carrier/impression transfer are optionally packed together as a kit, optionally as a sterile kit.

In some embodiments the above kit may also be packaged with a corresponding trephine and drill set.

In some embodiments the above kit may also be packaged with a corresponding healing abutment cap.

In some embodiments the above-mentioned kits may optionally be packaged in a sequence which matches the implant insertion order.

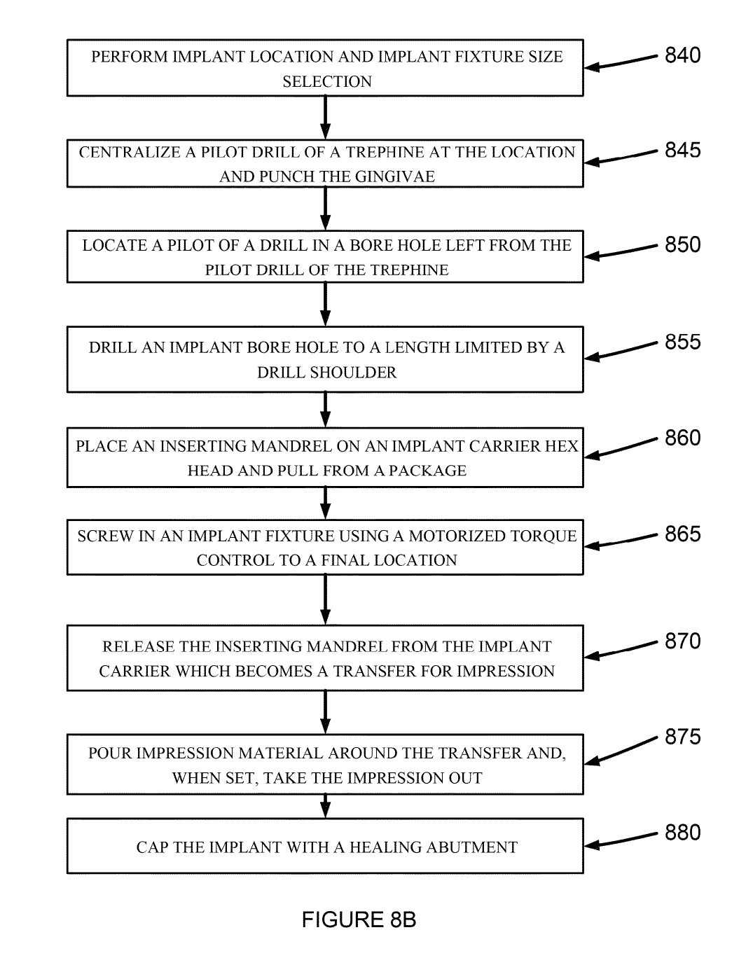

Reference is now made to FIGS. 8A-8B, which are simplified flow charts describing methods of performing dental implantation according to example embodiments of the invention.

FIG. 8A depicts a flow chart of a method of implanting a fixture for a dental implant and taking an impression during a procedure.

The method of FIG. 8A includes:

drilling a hole in mucosa while simultaneously drilling a smaller diameter concentric pilot hole in a jaw bone with the same drill 805;

inserting an implant fixture comprising an abutment connection socket into the jaw bone, wherein a stub is connected to the abutment connection socket 810;

placing a material for dental impression into a volume which includes the stub 815; and

pulling the dental impression off the implant fixture 820.

In some embodiments, the pulling the dental impression off the implant fixture comprises pulling the dental impression and the stub both off the implant fixture.

In some embodiments, the stub is an implant carrier.

In some embodiments, the inserting the implant fixture into the jaw bone includes inserting the implant fixture into the jaw bone using the implant carrier attached to the abutment connection socket of the implant fixture.

In some embodiments, after drilling the smaller diameter concentric pilot hole in the jaw bone, drilling out the pilot hole in the jaw bone to a diameter suitable for inserting an implant fixture.

In some embodiments, during the procedure, a provisional prosthetic tooth is attached to the implant fixture.

In some embodiments, a provisional prosthetic crown is attached to the implant fixture.

FIG. 8B depicts a flow chart of another example embodiment of a method of implanting a fixture for a dental implant and taking an impression during a procedure.

The method of FIG. 8B includes:

performing implant location and implant fixture size selection 840;

centralizing a pilot drill of a trephine at the location and punch the gingivae 845;

locating a pilot of a drill in a bore hole left from the pilot drill of the trephine 850;

drilling an implant bore hole to a length limited by a drill shoulder 855;

placing an inserting mandrel on an implant carrier hex head and pull from a package 860;

screwing in an implant fixture using a motorized torque control to a final location 865;

releasing the inserting mandrel from the implant carrier which becomes a transfer for impression 870;

pouring impression material around the transfer and, when set, taking the impression out 875;

capping the implant with a healing abutment 880.

It is expected that during the life of a patent maturing from this application many relevant implant fixture shapes and materials will be developed and the scope of the term implant fixture is intended to include all such new technologies a priori.

As used herein the term “about” refers to ±10%.

The terms “comprising”, “including”, “having” and their conjugates mean “including but not limited to”.

The term “consisting of” is intended to mean “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a unit” or “at least one unit” may include a plurality of units, including combinations thereof.

The words “example” and “exemplary” are used herein to mean “serving as an example, instance or illustration”. Any embodiment described as an “example or “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical, dental and medical arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A method of implanting a fixture for a dental implant and taking an impression comprising, during a procedure:
drilling a hole in mucosa while simultaneously drilling a smaller diameter concentric pilot hole in a jaw bone with the same drill;
inserting an implant fixture comprising an abutment connection socket into the jaw bone, wherein a stub is connected to the abutment connection socket;
placing a material for dental impression into a volume which includes the stub; and
pulling the dental impression off the implant fixture.

2. The method of claim 1 wherein the pulling the dental impression off the implant fixture comprises pulling the dental impression and the stub both off the implant fixture.

3. The method of claim 1 wherein:
the stub comprises an implant carrier.

4. The method of claim 3 wherein the inserting the implant fixture into the jaw bone comprises inserting the implant fixture into the jaw bone using the implant carrier attached to the abutment connection socket of the implant fixture.

5. The method of claim 1 and further comprising, after drilling the smaller diameter concentric pilot hole in the jaw bone, drilling out the pilot hole in the jaw bone to a diameter suitable for inserting an implant fixture.

6-35. (canceled)

36. A bone drill for drilling a hole for a dental implant fixture in a jaw bone comprising a non-cutting shoulder for limiting a depth of a hole produced by drilling using the bone drill.

37. The bone drill of claim 36 wherein the drill comprises a conical drilling surface.

38. The bone drill of claim 36 wherein the drill comprises a drilling surface with a continuously changing angle relative to a longitudinal axis of the bone drill, and wherein the shape of the drilling surface conforms to a shape of a dental implant fixture.

39. The bone drill of claim 36 wherein the drill comprises a plurality of conical drilling surfaces at different angles relative to a longitudinal axis of the bone drill.

40. A dental implant drill comprising:
a pilot drill configured for being capable of drilling in bone; and
a trephine attached concentrically to the pilot drill,
wherein a tip of the pilot drill extends more than 5 mm beyond a tip of the trephine and
a distance between the trephine and the pilot drill decreases toward a base of the pilot drill.

41. The dental implant drill of claim 40 wherein the distance between the trephine and the pilot drill decreases by an amount between 1 mm and 5 mm.

42. The dental implant drill of claim 40 wherein the trephine comprises a single cylindrical blade.

43. The dental implant drill of claim 40 wherein the trephine comprises a plurality of blades.

44. The dental implant drill of claim 40 wherein the pilot drill comprises a conical pilot drill.

45. The dental implant drill of claim 40 wherein the pilot drill comprises a plurality of conical drilling surfaces at different angles relative to an axis of the pilot drill.

46-49. (canceled)

50. A kit comprising a dental implant fixture and a dental implant drill comprising a pilot drill configured for being capable of drilling in bone and a trephine attached concentrically to the pilot drill, the pilot drill is shaped similarly to the dental implant fixture.
